(19) United States
(12) Patent Application Publication
(10) Pub. No.: US 2013/0164051 A1
(43) Pub. Date: Jun. 27, 2013

(54) CONDUCTIVE ROLLER, IMAGE-FORMING APPARATUS, AND PROCESS CARTRIDGE

(71) Applicants: Kentaro Ageishi, Ebina-shi (JP); Tetsuya Fujita, Ebina-shi (JP)

(72) Inventors: Kentaro Ageishi, Ebina-shi (JP); Tetsuya Fujita, Ebina-shi (JP)

(73) Assignee: FUJI XEROX CO., LTD., Tokyo (JP)

(21) Appl. No.: 13/533,629

(22) Filed: Jun. 26, 2012

(30) Foreign Application Priority Data
Dec. 22, 2011 (JP) 2011-282387

(51) Int. Cl. G03G 15/16

(52) U.S. Cl. 399/313

(57) ABSTRACT

A conductive roller includes a conductive core and a foamed elastic layer covering the conductive core. The foamed elastic layer contains at least three conductive rubbers having different volume resistivities within the range of less than about 1×10¹⁴ Ω cm, at least one insulating rubber having a volume resistivity of about 1×10¹⁴ Ω cm or more, and at least two conductive fillers.

### CROSS-REFERENCE TO RELATED APPLICATIONS

This application is based on and claims priority under 35 USC 119 from Japanese Patent Application No. 2011-282387 filed Dec. 22, 2011.

### BACKGROUND

(i) Technical Field

The present invention relates to conductive rollers, image-forming apparatuses, and process cartridges.

(ii) Related Art

Conductive rollers for use with electrophotographic image-forming apparatuses and inkjet image-forming apparatuses are fabricated by covering a conductive metal core with a conductive foamed elastomer. The conductive foamed elastomer is formed by dispersing a conductive material in a common elastomer to make the elastomer conductive and subjecting the elastomer to mechanical foaming with air or nitrogen or to chemical foaming with a foaming agent. Examples of elastomers include ethylene propylene diene monomer rubber (EPDM), nitrile butadiene rubber (NBR), styrene butadiene rubber (SBR), urethane rubber, silicone rubber, and Norsorex. Examples of conductive materials include carbon black, metal oxides, and organic and inorganic electrolytes.

### SUMMARY

According to an aspect of the invention, there is provided a conductive roller including a conductive core and a foamed elastic layer covering the conductive core. The foamed elastic layer contains at least three conductive rubbers having different volume resistivities within the range of less than about 1×10¹⁴ Ω cm, at least one insulating rubber having a volume resistivity of about 1×10¹⁴ Ω cm or more, and at least two conductive fillers.

### BRIEF DESCRIPTION OF THE DRAWINGS

Exemplary embodiments of the present invention will be described in detail based on the following figures, wherein:

FIG. 1 is a sectional view of an example of a conductive roller according to an exemplary embodiment; and

FIG. 2 is a schematic view of an example of an image-forming apparatus including the conductive roller according to the exemplary embodiment as a transfer roller.

### DETAILED DESCRIPTION

### Conductive Roller

A conductive roller according to an exemplary embodiment of the present invention will now be described in detail.

The conductive roller according to this exemplary embodiment includes a conductive core and a foamed elastic layer covering the conductive core. The foamed elastic layer contains at least three conductive rubbers having different volume resistivities within the range of less than 1×10¹⁴ Ω cm or about 1×10¹⁴ Ω cm, at least one insulating rubber having a volume resistivity of 1×10¹⁴ Ω cm or more or about 1×10¹⁴ Ω cm or more, and at least two conductive fillers.

Related-art conductive rollers for use as, for example, transfer rollers in electrophotographic image-forming apparatuses, transfer rollers on intermediate transfer belts or sheet transport/attraction belts, or charging rollers in inkjet image-forming apparatuses exhibit unstable electrical characteristics and transfer field, particularly, variation in resistivity with environmental changes such as temperature and humidity changes.

The conductive roller according to this exemplary embodiment includes a foamed elastic layer containing at least three conductive rubbers having different volume resistivities and at least one insulating rubber, that is, at least four rubber materials, and at least two conductive fillers. A mixture of insulating and conductive rubber materials may form a sea-island structure including the “sea” of the conductive rubbers and the “islands” of the insulating rubber. Mixing together at least four rubber materials and at least two conductive fillers may provide fine islands, thus forming a sea-island structure with improved miscibility at rubber interfaces. In addition, the conductive fillers may be distributed over the interfaces in the sea-island structure, which may alleviate concentration of the conductive fillers and therefore improve the dispersibility thereof. The conductive fillers localized at the sea-island interfaces in the fine structure may provide a larger number of conduction paths, thus stabilizing the electrical characteristics. The conductive fillers may also provide conductivity with less variation in resistivity, thus reducing the variation in resistivity with environmental changes such as temperature and humidity changes.

The conductive roller according to this exemplary embodiment may enable stable image transfer, sheet transport and attraction, and formation of a first transfer image despite variations in the resistivity of sheets and transfer field. In addition, the conductive roller may provide a wide resistivity design control range to enable stable formation of a transfer field depending on the image-forming speed, the resistance of the recording medium, and the environment.

For ionically conductive rubber materials such as urethane rubber, NBR, and CR, the conductive fillers may reduce a decrease in resistance at high temperature and high humidity (for example, at 28° C. and 85% RH) and an increase in resistance due to a low moisture level at low temperature and low humidity (for example, at 10° C. and 15% RH). Thus, the conductive fillers may maintain stable resistance in any environment.

The resistivity of olefin rubbers such as EPDM and butyl rubber, which are highly insulating rubbers, varies in the range of 10¹⁴ to 10¹⁶ Ω cm with changes in the voltage applied and the content, while the resistivity of more conductive and hygroscopic rubbers such as SBR, urethane rubber, NBR, and CR varies in a lower range, namely, 10⁸ to 10¹³ Ω cm, with environmental changes involving changes in humidity. Their resistivity variations depend on the composition, contents, copolymerization, blocking, and degree of polymerization of the components because of the water retention properties of an alkylene oxide component or a polar component or ionic component (such as free water, an impurity ionic component such as a halogen, or an ionic component that is hydrated or has a hydrogen or ether bond) of the functional group (such as a double bond, nitrile group, or urethane bond). An epichlorohydrin component has a highly ionically conductive structure including an ionic component (such as a free hydroxy group or chlorine) with an ether bond. The conductivity of ethylene oxide (PEG)-propylene oxide (PPG)-allyl glycidyl ether (AGE) terpolymer can be adjusted within the range of 10⁴ to 10⁸ Ω cm depending on the molecular weight of the ether component, the contents of PEG and PPG, and the intramolecular crosslink density upon rubber vulcanization. The addition of conductive fillers such as carbon black, conductive inorganic oxides, or metal oxides may stabilize low-resistivity-range adjustment, the resistivity adjustment range of the rubber components, and conductivity adjustment among the conductive fillers with voltage changes, effectively and in a way that reduces environmental variations.

The contributions of the conductive rubbers and the insulating rubber contained in the foamed elastic layer formed around the core can be separated by removing each rubber component to determine, for example, the effect of the component on resistivity, the dispersibility, the miscibility, the SP, and the ion content and performing procedures such as mixing, dispersing, vulcanizing, foaming, and extracting. If a single component is added, it is difficult to separate the contribution of the conductivity of each component because the conductivity, foamability, vulcanizability, and miscibility vary. The contribution of the sea-island structure to resistivity has yet to be well understood because the types and contents of the individual components and the dispersibility of the conductive fillers vary. Examination under an electron microscope such as a transmission electron microscope (TEM) shows that a blend or mixture of EPDM and other components forms a large sea-island structure and that the addition of the third and subsequent components allows formation of a fine sea-island structure and stable aggregation of carbon black at the interfaces of the polar rubber components. The blending of multiple rubber components and the stable aggregation and dispersion of the conductive fillers may provide the superior environmental stability of this exemplary embodiment.

### Rubber Materials

As the conductive rubbers having volume resistivities of less than 1×10¹⁴ Ω cm or about 1×10¹⁴ Ω cm, the foamed elastic layer may contain at least three rubbers selected from the group consisting of NBR, CR, ECO, urethane rubber, butadiene rubber, and SBR. As the insulating rubber having a volume resistivity of 1×10¹⁴ Ω cm or more or about 1×10¹⁴ Ω cm or more, the foamed elastic layer may contain at least one rubber selected from the group consisting of EPDM, silicone rubber, and butyl rubber.

Of the rubber materials listed above, NBR preferably has a low to medium high acrylonitrile content, specifically, 15 to 55 mol %, more preferably 15 to 35 mol %.

SBR preferably has a styrene content of 15 to 55 mol %, more preferably 15 to 35 mol % (medium-high styrene content).

Examples of dienes for EPDM include ethylidenenorbornene, 1,4-hexadiene, dicyclopentadiene, and isophorones.

As the conductive rubbers, the foamed elastic layer may contain at least one rubber (low-resistivity rubber) selected from the group consisting of ECO and urethane rubber, at least one rubber (high-resistivity rubber) selected from the group consisting of butadiene rubber and SBR, and at least one rubber (medium-resistivity rubber) selected from the group consisting of NBR and CR.

The addition of a low-resistivity rubber having a volume resistivity of 1×10⁶ to 1×10⁷ Ω cm, such as ECO or urethane rubber, may provide a wider resistivity adjustment range, and may allow the conductive roller including the foamed elastic layer to have improved stability of electrical characteristics required for a transfer, charging, or neutralizing region, an extended service life, reduced degradation, environmental variations of an order of magnitude or less in the range of 1×10⁴ to 1×10¹¹ Ω cm within the required resistivity adjustment range, and reduced central resistivity variation due to electrical fatigue degradation after energization.

In particular, the combination of the conductive and insulating rubbers may be a combination of NBR, ECO, SBR, and EPDM or a combination of CR, ECO, SBR, and EPDM. These combinations may provide a transfer roller that exhibits stable resistivity with a variation of two orders of magnitude or less in a variety of environments from high-temperature, high-humidity environments to low-temperature, low-humidity environments in a wide conductivity control range, namely, 1×10³ to 1×10¹⁰ Ω cm, which is required for a transfer field.

The content of the low-resistivity rubber (such as ECO or urethane rubber) is preferably 5% to 50% by mass or about 5% to about 50% by mass, more preferably 10% to 40% by mass or about 10% to about 40% by mass, still more preferably 10% to 20% by mass or about 10% to about 20% by mass, of the total amount of rubber components.

The content of the high-resistivity rubber (such as butadiene rubber or SBR) is preferably 5% to 50% by mass or about 5% to about 50% by mass, more preferably 10% to 40% by mass or about 10% to about 40% by mass, still more preferably 20% to 30% by mass or about 20% to about 30% by mass.

The content of the medium-resistivity rubber (such as NBR or CR) is preferably 5% to 50% by mass or about 5% to about 50% by mass, more preferably 10% to 40% by mass or about 10% to about 40% by mass, still more preferably 20% to 30% by mass or about 20% to about 30% by mass.

The content of the insulating rubber (such as EPDM, silicone rubber, or butyl rubber) is preferably 10% to 40% by mass or about 10% to about 40% by mass, more preferably 30% to 40% by mass or about 30% to about 40% by mass. In particular, if the content of the insulating rubber is 30% to 40% by mass or about 30% to about 40% by mass, the conductive roller may exhibit less material degradation due to application of a transfer field, release discharge on a recording medium and a belt in sheet transport, and discharge between belts because of the addition of the material with high ozone resistance.

If the content of the insulating rubber is 30% by mass or more, it may reduce degradation in resistivity over time during energization at a predetermined voltage or current and also improve the ozone resistance of the rubber materials. If the content of the insulating rubber is 40% by mass or less, the rubber materials may form a fine, homogeneous, stable sea-island structure with reduced disruption, thus inhibiting an increase in the resistivity of the foamed elastic layer.

If the contents of the high-resistivity rubber and the medium-resistivity rubber are within the above ranges, they may be more miscible with the conductive fillers as a result of reduced heat generation during the mixing of the conductive fillers, thus increasing the dispersion stability of additives and the conductive fillers during the mixing. The conductive roller may therefore exhibit less variation in resistivity with environmental changes such as temperature and humidity changes, depends less on the voltage applied, and has low hardness and high stability. In view of resistivity and ozone resistance, the content of a single insulating rubber in the blended rubber containing at least three rubbers may be 30% to 40% by mass or about 30% to about 40% by mass, and the total content of two or more insulating rubbers in the blended rubber containing at least three rubbers may be 50% to 90% by mass or about 50% to about 90% by mass.

### Conductive Fillers

Examples of conductive fillers available in this exemplary embodiment include carbon black, metal oxides, and organic and inorganic electrolytes, of which carbon black is preferred.

Examples other than carbon black include graphite and metal oxides such as tin oxide and titanium oxide.

The conductive fillers may be two carbon blacks with different properties, particularly a combination of two carbon blacks with different oil absorbencies. For example, the conductive fillers may be a combination of Ketjen black, which has high oil absorbency and conductivity, and thermal black, such as FT or MT, which is a type of soft carbon with low oil absorbency and superior rubber reinforcement properties. This combination may provide conductivity with less variation in resistivity when added in relatively small amounts.

Examples of Ketjen black include Ketjen black EC, Ketjen black EC-600, and Ketjen black EC-600JD (available from Lion Akzo Co., Ltd.).

Examples of thermal black include FT carbon and MT carbon (available from Asahi Carbon Co., Ltd.), N990 ARO90 (available from J.M. Huber Corporation), HTC #20 (available from Chubu Carbon), MT N990 (available from Evonik Degussa GmbH), Sevacarb MT (available from Columbian Chemicals Company), and #3030B and #4013B (available from Mitsubishi Chemical Corporation).

For example, the mass ratio of Ketjen black to thermal black is preferably 1:1 to 1:8, more preferably 1:2 to 1:5.

For example, the content of Ketjen black may be 2 to 20 parts by mass based on 100 parts by mass of the total amount of rubber components, and the content of thermal black may be 10 to 40 parts by mass based on 100 parts by mass of the total amount of rubber components, depending on the proportions of the rubber materials. The addition of these two carbon blacks with different conductivities may reduce resistivity variations with sharp voltage changes, reduce variations in the conductivity of the conductive roller itself, and increase moldability with stable miscibility in continuous molding, kneading, and filler mixing, thus contributing to lot stability in mass production.

### Additives

Examples of additives applicable to the foamed elastic layer include vulcanizing agents, foaming agents, vulcanization accelerators, anti-aging agents, softeners, plasticizers, reinforcing agents, and fillers. Additives other than vulcanizing agents, foaming agents, and vulcanization accelerators may be added as needed. In particular, the use of additives that tend to cause bleeding, such as softeners and plasticizers, may be avoided.

Examples of vulcanizing agents include sulfur, organosulfur compounds, and organic peroxides. Examples of organosulfur compounds include tetramethylthiuram disulfide and N,N′-dithiobismorpholine. Examples of organic peroxides include dicumyl peroxide and benzoyl peroxide. The amount of vulcanizing agent added is preferably 0.3 to 4 parts by mass, more preferably 1.0 to 3.5 parts by mass, based on 100 parts by mass of the total amount of rubber components.

The vulcanization accelerator may be selected from various vulcanization accelerators used in the related art, preferably from sulfonamide vulcanization accelerators. The amount of vulcanization accelerator added is preferably 0.3 to 4 parts by mass, more preferably 0.5 to 3 parts by mass, based on 100 parts by mass of the total amount of rubber components.

The foaming agent may be selected from various vulcanization accelerators used in the related art, preferably from azodicarbonamide (ADCA) foaming agents, which tend to retard the vulcanization of the entire rubber, thus inhibiting rapid vulcanization of some rubber phases.

Examples of anti-aging agents include imidazoles such as 2-mercaptobenzimidazole; amines such as phenyl-α-naphthylamine, N,N′-di-β-naphthyl-p-phenylenediamine, and N-phenyl-N′-isopropyl-p-phenylenediamine; and phenols such as di-tert-butyl-p-cresol and styrenated phenol.

### Method for Manufacturing Conductive Roller

Next, an example of a method for manufacturing the conductive roller according to this exemplary embodiment will be described.

At least three conductive rubbers having different volume resistivities and at least one insulating rubber are preblended in order of miscibility and are finally blended with EPDM. At least two conductive fillers and optional additives are added thereto. The mixture is kneaded and is molded into a cylinder of predetermined length by extrusion molding. The cylinder is fitted around a cylindrical conductive core to perform vulcanization. The vulcanization process may be can vulcanization or another process such as non-pressure oven vulcanization. The vulcanization is typically performed at 140° C. to 170° C. for 0.5 to 6 hours, although the conditions vary with the types and contents of the rubber materials used. The mixture is foamed during the vulcanization process to yield a conductive foamed elastic tube. The foaming magnification is preferably 140% to 400% by volume, more preferably 200% to 350% by volume.

The conductive core may be, for example, a stainless steel, copper, iron, nickel-plated iron, or aluminum metal core (shaft).

A resistive layer may be formed on the foamed elastic layer. The resistive layer is formed by coating or impregnating the foamed elastic layer with a coating material prepared by dispersing a conductive filler such as carbon black or a metal oxide (such as titanium oxide or tin oxide) in a polymer such as polyurethane, acrylic, or nylon and curing the coating by heat drying. The coating may be cured by drying layers of the coating with heat simultaneously or after each layer is formed. The coating material used for the resistive layer may be an organic solvent-based coating material or an emulsion such as water-based urethane, which dries relatively slowly.

### Properties

### Thickness

The foamed elastic layer preferably has a thickness of 1 to 50 mm, more preferably 10 to 30 mm.

### Nip Resistance

As noted above, the conductive roller according to this exemplary embodiment has good electrical characteristics. Specifically, the foamed elastic layer preferably has a nip resistance at 23° C. and 55% RH of 10⁴ to 10¹⁰ Ω/cm, more preferably 10⁷ to 10¹⁰ Ω/cm, still more preferably 10⁷ to 10⁹ Ω/cm. A nip resistance of 10⁴ Ω/cm or more prevents insufficient charge of a recording medium when the conductive roller is used as a transfer roller in an electrophotographic image-forming apparatus, thus avoiding insufficient attraction of the recording medium. A nip resistance of 10¹⁰ Ω/cm or less prevents excessive charge of a recording medium when the conductive roller is used as a transfer roller in an electrophotographic image-forming apparatus, thus avoiding image defects. The nip resistance, however, is not necessarily constrained by the structure of the image-forming apparatus according to this exemplary embodiment. For example, if a belt is disposed between a transfer roller and a recording medium, the nip resistance may be adjusted to less than 10⁷ Ω cm taking into account the resistance of the belt.

The nip resistance is measured using a cylindrical-electrode HR probe of HIRESTA IP available from Mitsubishi Petrochemical Co., Ltd. while applying a voltage of 1,000 V (10-second charge) under a load of 1 Kg. The nip resistance of the foamed elastic layer is measured at a nip on an aluminum drum.

The conductive roller according to this exemplary embodiment preferably has a volume resistivity at 28° C. and 85% RH of 10¹⁰ Ω cm or less, more preferably 10⁹ Ω cm or less, a volume resistivity at 10° C. and 15% RH of 10⁴ to 10⁹ Ω cm, more preferably 10⁷ to 10⁹ Ω cm, and a difference in nip resistance between both environments of an order of magnitude or less.

The volume resistivities (at a nip) at 28° C. and 85% RH and at 10° C. and 15% RH are determined as follows. The conductive roller is energized by applying a voltage of 3 kV for 100 hours under the above temperature-humidity conditions. Two stainless steel rollers having a diameter of 12 mm and a length of 330 mm are put into contact with the conductive roller to a depth of 0.2 mm at a distance of 10 mm from each other in the circumferential direction. A direct-current (DC) voltage of 1 kV is applied across the metal rollers, and the current (I) is read after 10 seconds. The surface resistivity Rs is determined by the following equation:

Rs=LV/GI

(where L is the length (cm) of the conductive roller, and G is the distance (cm) between the two metal rollers).

A piece having a height of 1 cm is cut from the conductive roller, is held between metal plates, and is supplied with a DC voltage of 100 V to measure the resistance after 10 seconds. The volume resistivity is calculated from the measured resistance.

### Asker C Hardness

The foamed elastic layer of the conductive roller according to this exemplary embodiment preferably has an Asker C hardness of 20° to 80°, more preferably 30° to 60°. An Asker C hardness of 80° or less may ensure a sufficient amount of nip, thus providing stable charge and transfer properties. An Asker C hardness of 20° or more may ensure an appropriate nip area, thus avoiding variations in speed relative to a recording medium.

The Asker C hardness refers to the rebound hardness under a load of 200 g and is measured using an Asker C durometer available from Kobunshi Keiki Co., Ltd. in accordance with JIS K 7312 or JIS S 6050.

### Use

The conductive roller according to this exemplary embodiment is used as, for example, a charging roller that charges the surface of an image carrier in an electrophotographic copier or electrostatic printer, a transfer roller that transfers a toner image from an image carrier to a transfer medium, a toner transport roller that transports toner to an image carrier, or a cleaning roller that removes toner from an image carrier. The conductive roller can also be used as, for example, a charging roller that charges an intermediate transfer member before ink is ejected from an inkjet head in an inkjet image-forming apparatus.

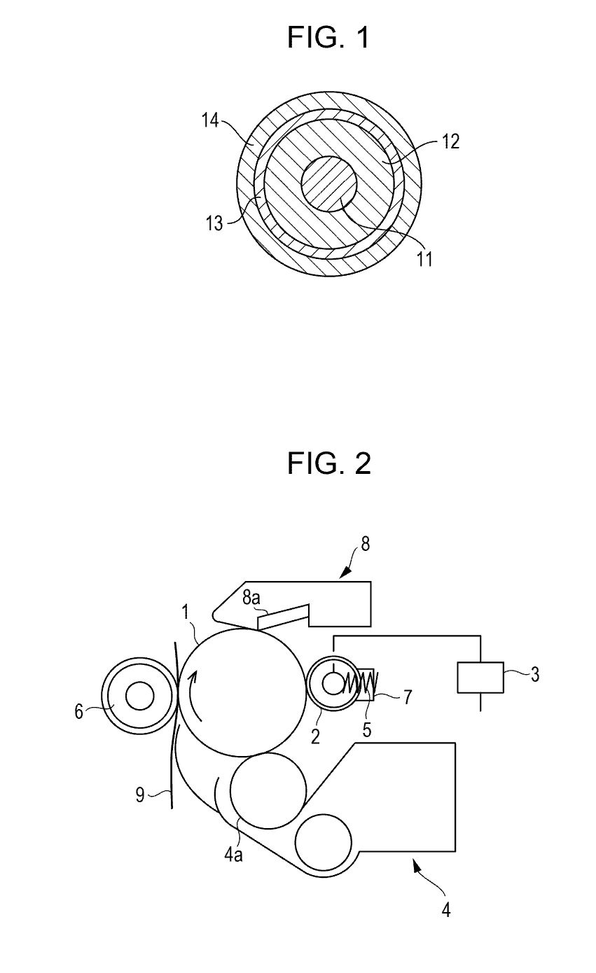

FIG. 1 is a sectional view of a transfer roller as an example of the conductive roller according to this exemplary embodiment. Referring to FIG. 1, the transfer roller includes a conductive core 11, a foamed elastic layer 12, a first resistive layer 13, and a second resistive layer 14.

FIG. 2 is a schematic view of an example of an image-forming apparatus including the conductive roller according to this exemplary embodiment as a transfer roller. This image-forming apparatus is an electrophotographic laser beam printer.

Referring to FIG. 2, as an image carrier, a photoreceptor drum 1 such as an organic photoconductor is rotated by a drive unit (not shown) at a predetermined process speed (switched between 28 and 56 mm/sec) in the direction of the arrow. A charging roller 2 contacts the surface of the photoreceptor drum 1 to charge it to a particular potential.

A power supply 3 applies to the charging roller 2, for example, an oscillating voltage containing a DCG, LV component having a voltage of −350 V and a sinusoidal AC component having a frequency of 350 Hz and a voltage of 2,000 Vpp, where LV denotes σv, which is a component of volume resistivity, and DCG denotes an AC component containing a DC component. The DC component (−350 V) superimposed on the AC bias (2,000 V) by the charging roller 2 may stabilize the surface potential of the photoreceptor drum 1, while the transfer roller may be controlled depending only on the DC voltage. The charging roller 2 charges the surface of the photoreceptor drum 1 to −350 V, which is equal to the DC component of the applied voltage. A laser write device (not shown) then exposes the surface of the photoreceptor drum 1 with image light based on image information to form an electrostatic latent image based on the image information.

A developing roller 4a of a developing device 4 supplies a developer, such as a one-component magnetic developer, to develop the electrostatic latent image formed on the photoreceptor drum 1, thus forming a toner image. The transfer roller 6 is then charged to transfer the toner image to a transfer sheet 9 fed at a predetermined timing as a recording medium. The transfer roller 6 is supplied with a constant transfer current controlled within the range of 3 to 5 μA.

The transfer sheet 9 having the toner image transferred thereto is separated from the surface of the photoreceptor drum 1 after discharge by a discharging device for erasing (not shown) and is then transported to a fixing device (not shown). After the toner image is fixed on the transfer sheet 9, the transfer sheet 9 is ejected outside the apparatus, thus completing the image-forming cycle.

After the transfer of the toner image is complete, a cleaning blade 8a of the cleaning device 8 removes residual toner from the surface of the photoreceptor drum 1 to prepare for the next image-forming cycle. In FIG. 2, a pressing spring 5 causes the charging roller 2 to contact the surface of the photoreceptor drum 1, and a cleaning pad 7 cleans the surface of the charging roller 2.

### EXAMPLES

The present invention is further illustrated by the following non-limiting examples and comparative examples, where parts are parts by mass unless otherwise specified.

### Example 1

A foamed elastic layer is formed on a stainless steel core (8 mm diameter conductive core).

First, 20 parts of NBR (DN211 from Zeon Corporation), 40 parts of EPDM (EP33 from JSR Corporation), 30 parts of SBR (from Denki Kagaku Kogyo Kabushiki Kaisha), and 10 parts of ECO (610 from Daiso Co., Ltd.) are blended together.

The NBR contains 33 mol % of acrylonitrile and has a volume resistivity of 10¹⁰ Ω cm.

The EPDM contains 5-ethylidene-2-norbornene as a diene and has a volume resistivity of 10¹⁴ Ω cm.

The SBR contains 30 mol % of styrene and has a volume resistivity of 10¹¹ Ω cm.

The ECO has a volume resistivity of 10⁷ Ω cm.

To the blend of the four rubber materials are added 28 parts of Asahi Thermal (HS 100 from Asahi Carbon Co., Ltd., DVB absorption: 28 ml/g) and 6 parts of Ketjen black (EC from Lion Akzo Co., Ltd.), as two conductive carbon blacks, 1.5 parts of sulfur (from Tsurumi Chemical, Co., Ltd.), as a vulcanizing agent, 5 parts of a vulcanization accelerator (NOCCELER M from Ouchi Shinko Chemical Industrial Co., Ltd.), 1 part of stearic acid, and 6 parts of a foaming agent (OBSH). The blend is kneaded with a roller and is molded into a cylinder by extrusion molding. The cylinder is cut to A3 size, is fitted around the core, and is foamed and vulcanized in a high-pressure steam can at 160° C. for 30 minutes. The foamed layer is polished to a diameter of 18.7 mm.

The properties of the thus-formed conductive roller are measured and evaluated as follows.

### Nip Resistance

The nip resistance of the foamed elastic layer is measured at high temperature and high humidity (28° C. and 85% RH) using a cylindrical-electrode HR probe of HIRESTA IP available from Mitsubishi Petrochemical Co., Ltd. while applying a voltage of 1,000 V (10-second charge) under a load of 1 Kg. The nip resistance of the foamed elastic layer is measured at a nip on an aluminum drum. The foamed elastic layer of the conductive roller of Example 1 has a nip resistance of 10^{7.4} Ω (7.4 logΩ).

### Environmental Variation in Nip Resistance

The nip resistance of the foamed elastic layer is measured at low temperature and low humidity (10° C. and 15% RH) by the procedure described above. The variation in resistance (nip resistance) due to the environmental change in temperature and humidity (difference between the high-temperature, high-humidity environment and the low-temperature, low-humidity environment) is calculated. The conductive roller of Example 1 exhibits an environmental variation in nip resistance of 0.3 order of magnitude.

### Asker C Hardness

The Asker C hardness of the foamed elastic layer is measured by the procedure described above. The foamed elastic layer of the conductive roller of Example 1 has an Asker C hardness of 37°.

Variation in Nip Resistance after Energization Test

The conductive roller is energized by applying a voltage of 3 kV in a low-temperature, low-humidity environment (10° C. and 15% RH) for 100 hours. The nip resistance is then measured in a high-temperature, high-humidity environment (28° C. and 85% RH) by the procedure described above. The conductive roller of Example 1 exhibits a variation in nip resistance of 0.8 order of magnitude after the energization test, which is acceptable in terms of print quality.

Change in Asker C Hardness after Energization Test

The Asker C hardness of the foamed elastic layer after the energization test is measured by the procedure described above. The foamed elastic layer of the conductive roller of Example 1 does not change in Asker C hardness.

Change in External Appearance after Energization Test

The foamed elastic layer after the energization test is visually inspected for any change in external appearance. The foamed elastic layer of the conductive roller of Example 1 does not change in external appearance.

### Image Quality Evaluation

An image is formed by the procedure described later and is evaluated for image quality.

The conductive roller is mounted as the transfer roller 6 in the electrophotographic image-forming apparatus illustrated in FIG. 2. An image is printed and evaluated for transfer properties in a high-temperature, high-humidity environment (28° C. and 85% RH) and image quality in a low-temperature, low-humidity environment (10° C. and 15% RH) according to the following criteria:

A: The transfer properties are good, and the image has good image quality without density variation.

B: The image quality varies locally.

C: The transfer properties are poor, and the image has image defects (density variation).

### Examples 2 to 3 and Comparative Example 1

Conductive rollers are fabricated and evaluated by the same procedures as in Example 1 except that the contents of the rubber materials and carbon black are changed to those shown in Table 1 below.

TABLE 1

| | | | | | | | | Comparative | |
|---|---|---|---|---|---|---|---|---|---|
| | | Example 1 | | Example 2 | | Example 3 | | Example 1 | |
| Rubber | NBR | 20 | parts | 30 | parts | 20 | parts | 40 | parts |
| material | EPDM | 40 | parts | 30 | parts | 40 | parts | 60 | parts |
| | SBR | 30 | parts | 30 | parts | 20 | parts | — | |
| | ECO | 10 | parts | 10 | parts | 20 | parts | — | |
| Carbon black | EC | 6 | parts | 5 | parts | 7 | parts | 6 | parts |
| | HS | 28 | parts | 25 | parts | 31 | parts | 28 | parts |
| Foamed | Nip resistance | 7.4 | logΩ | 8.3 | logΩ | 6.8 | logΩ | 7.6 | logΩ |
| elastic layer | (at high | | | | | | | | |
| | temperature and | | | | | | | | |
| | high humidity) | | | | | | | | |
| | Environmental | 0.3 order of | | 0.2 order of | | 0.4 order of | | 1.0 order of | |
| | variation | magnitude | | magnitude | | magnitude | | magnitude | |
| | Asker C hardness | 37° | | 33° | | 40° | | | 41° |
| After | Nip resistance | 8.2 | logΩ | 9.5 | logΩ | 7.8 | logΩ | 10.5 | logΩ |
| energization | (at high | | | | | | | | |
| test | temperature and | | | | | | | | |
| | high humidity) | | | | | | | | |

| | | | | |
|---|---|---|---|---|
| Variation in nip | 0.8 order of | 1.2 orders of | 1.0 order of | 2.9 orders of |
| resistance | magnitude | magnitude | magnitude | magnitude |
| Change in Asker C | None | None | None | Changed to |
| hardness | | | | 38° |
| Change in external | None | None | None | Surface cell |
| appearance | | | | deformation |

| | | | | |
|---|---|---|---|---|
| Image quality | A | B: local | A | C |
| | | variations | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A conductive roller comprising:
a conductive core; and
a foamed elastic layer covering the conductive core, the foamed elastic layer containing at least three conductive rubbers having different volume resistivities within the range of less than about 1×10¹⁴ Ω cm, at least one insulating rubber having a volume resistivity of about 1×10¹⁴ Ω cm or more, and at least two conductive fillers.

2. The conductive roller according to claim 1, wherein
the conductive rubbers are at least three rubbers selected from the group consisting of nitrile butadiene rubber, chloroprene rubber, epichlorohydrin rubber, urethane rubber, butadiene rubber, and styrene butadiene rubber; and
the insulating rubber is at least one rubber selected from the group consisting of ethylene propylene diene monomer rubber, silicone rubber, and butyl rubber.

3. The conductive roller according to claim 2, wherein the conductive rubbers and the insulating rubber are nitrile butadiene rubber, epichlorohydrin rubber, styrene butadiene rubber, and ethylene propylene diene monomer rubber or chloroprene rubber, epichlorohydrin rubber, styrene butadiene rubber, and ethylene propylene diene monomer rubber.

4. The conductive roller according to claim 1, wherein the content of the insulating rubber is about 30% to about 40% by mass of the total amount of rubber components.

5. The conductive roller according to claim 2, wherein the content of the insulating rubber is about 30% to about 40% by mass of the total amount of rubber components.

6. The conductive roller according to claim 3, wherein the content of the insulating rubber is about 30% to about 40% by mass of the total amount of rubber components.

7. The conductive roller according to claim 1, wherein
the conductive rubbers are at least one low-resistivity rubber selected from the group consisting of epichlorohydrin rubber and urethane rubber, at least one medium-resistivity rubber selected from the group consisting of nitrile butadiene rubber and chloroprene rubber, and at least one high-resistivity rubber selected from the group consisting of butadiene rubber and styrene butadiene rubber; and
the insulating rubber is at least one rubber selected from the group consisting of ethylene propylene diene monomer rubber, silicone rubber, and butyl rubber.

8. The conductive roller according to claim 7, wherein
the content of the low-resistivity rubber is about 10% to about 20% by mass of the total amount of rubber components;
the content of the medium-resistivity rubber is about 20% to about 30% by mass of the total amount of rubber components;
the content of the high-resistivity rubber is about 20% to about 30% by mass of the total amount of rubber components; and
the content of the insulating rubber is about 30% to about 40% by mass of the total amount of rubber components.

9. An image-forming apparatus comprising:
an image carrier;
a charging device that charges a surface of the image carrier;
a latent-image forming device that forms an electrostatic latent image on the image carrier charged by the charging device;
a developing device that develops the electrostatic latent image on the image carrier with a toner to form a toner image; and
a transfer roller that is disposed in contact with the image carrier and to which a transfer voltage is applied to transfer the toner image to the recording medium as the recording medium is inserted between the image carrier and the transfer roller, the transfer roller comprising the conductive roller according to claim 1.

10. A process cartridge attachable to and detachable from an image-forming apparatus, the process cartridge comprising:
at least one of an image carrier, a charging device that charges a surface of the image carrier, a latent-image forming device that forms an electrostatic latent image on the image carrier charged by the charging device, a developing device that develops the electrostatic latent image on the image carrier with a toner to form a toner image, and a cleaning device that cleans the surface of the image carrier; and
a transfer roller that is disposed in contact with the image carrier and to which a transfer voltage is applied to transfer the toner image to the recording medium as the recording medium is inserted between the image carrier and the transfer roller, the transfer roller comprising the conductive roller according to claim 1.
